(19) United States
(12) Patent Application Publication
(10) Pub. No.: US 2013/0020187 A1
(43) Pub. Date: Jan. 24, 2013

(54) KEY CAP STRUCTURE AND ELECTRONIC DEVICE THEREWITH

(71) Applicants: Jhih-Ming Chen, New Taipei City (TW); Min-Hao Tang, New Taipei City (TW)

(72) Inventors: Jhih-Ming Chen, New Taipei City (TW); Min-Hao Tang, New Taipei City (TW)

(21) Appl. No.: 13/467,061

(22) Filed: May 9, 2012

(30) Foreign Application Priority Data
Jul. 21, 2011 (TW) 100125828

(51) Int. Cl. H01H 13/14

(52) U.S. Cl. 200/520

(57) ABSTRACT

A key cap structure for disposing on a housing and corresponding to a circuit module is disclosed. The circuit module includes a circuit board and two contact portions disposed on the circuit board. The key cap structure comprises a top wall, a pair of side portions and a secure portion. The top wall has two press zones and a connect zone connects between the press zones. The press zones correspond to the contact portions respectively. The side portions connect to the press zones of the top wall respectively and extend downwardly and space apart from each other. The discontinuous structure between the side portions and the secure portion permits larger range of deformation formed in the top wall when the press zone is pressed downwardly. And the user only needs to apply less force to press on the top wall.

### BACKGROUND OF THE INVENTION

1. Field of the Invention

The present invention relates to a key cap structure an electronic device therewith, and more specifically, to a key cap structure capable of being operated by less pressing force and an electronic device therewith.

2. Description of the Prior Art

Please refer to FIG. 1. FIG. 1 is a schematic drawing of a key cap 9 in the prior art. The key cap 9 is made of resilient material and formed in a strip structure. The key cap 9 includes a top wall 91 and an edge portion 92 connected to the top wall 91 and extending downwardly. The edge portion 92 is closed and in an annular shape. The edge portion 92 has an L-shaped vertical section. As the key cap 9 is installed on a circuit board 93, a left area 991 and a right area 912 of the top wall 91 are respectively utilized for pressing switches 94 disposed thereunder. Accordingly, the key cap 9 is applied for two keyswitches. However, it is not easy to press the left area 991 or the right area 912 of the top wall 91 for deformation due to the integrated key cap 9 and the closed and annular edge portion 92. A user has to apply greater pressing force to generate enough deformation of the left area 991 or the right area 912 of the top wall 91 for contacting the switches 94 disposed thereunder, and it affects the operating feeling of the key cap 9.

### SUMMARY OF THE INVENTION

An embodiment of the invention provides a key cap structure capable of being operated by less pressing force and an electronic device therewith, to solve the problems mentioned above.

According to an embodiment of the invention, a key cap structure is for disposing on a housing and corresponding to a circuit module comprising a circuit board and two contact portions disposed on the circuit board. The key cap structure includes a top wall comprising two press zones respectively disposed corresponding to the two contact portions, and a connect zone connected between the two press zones. The key cap structure further includes a pair of side portions respectively connected to the two press zones of the top wall and extending downwardly. The pair of side portions is spaced apart from each other. The key cap structure further includes a secure portion connected to the connect zone of the top wall and extending downwardly between the pair of side portions, for securing the housing.

According to an embodiment of the invention, each side portion comprises a surrounding wall extending from the corresponding press zone downwardly, each surrounding wall comprises two first ends in a same direction, and the first ends of the surrounding walls of the pair of side portions face each other.

According to an embodiment of the invention, each side portion further comprises a flange extending from a bottom of the surrounding wall in a direction away from the top wall, the flange is located on a plane parallel to a plane whereon the top wall is located, each flange comprises two second ends respectively parallel with the first ends of the corresponding surrounding wall, and two free sections are respectively formed below the top wall and between the two second ends and the two first ends.

According to an embodiment of the invention, the secure portion includes two connect sections extending from the connect zone downwardly and disposed between the surrounding walls of the pair of side portions, and two fix sections respectively extending from the two connect sections and away from the top wall. The two fix sections are disposed between the flanges of the pair of side portions and located on a plane parallel to a plane whereon the top wall is located.

According to an embodiment of the invention, the key cap structure further includes a support rib extending from the connect zone of the top wall downwardly and disposed between the two connect sections.

According to an embodiment of the invention, a width of each connect section is substantially less than or equal to a width of the corresponding fix section along a dimensional direction of the two press zones and the connect zone of the top wall.

According to an embodiment of the invention, a width of the support rib is less than the width of the fix section along the dimensional direction.

According to an embodiment of the invention, an electronic device includes a housing, an electronic component module disposed inside the housing, and a circuit module including a circuit board disposed inside the housing and electrically connected to the electronic component module, and a plurality of contact portions disposed on the circuit board. The electronic device further includes a key cap structure disposed on the housing. The key cap structure includes a top wall including two press zones respectively disposed corresponding to the plurality of contact portions, and a connect zone connected between the two press zones. The key cap structure further includes a pair of side portions respectively connected to the two press zones of the top wall and extending downwardly. The pair of side portions is spaced apart from each other. The key cap structure further includes a secure portion connected to the connect zone of the top wall and extending downwardly between the pair of side portions, for securing the housing.

According to an embodiment of the invention, the discontinuous structure between the side portions and the secure portion of the key cap structure permits larger range of deformation formed in the top wall when the press zone of the top wall is pressed downwardly.

Accordingly, the user only needs to apply less pressing force on the top wall to generate enough deformation of the top wall for contacting the contact portion, so as to increase convenience and operational feeling of the key cap structure of the present invention.

These and other objectives of the present invention will no doubt become obvious to those of ordinary skill in the art after reading the following detailed description of the embodiment that is illustrated in the various figures and drawings.

### BRIEF DESCRIPTION OF THE DRAWINGS

FIG. 1 is a schematic drawing of a key cap in the prior art.

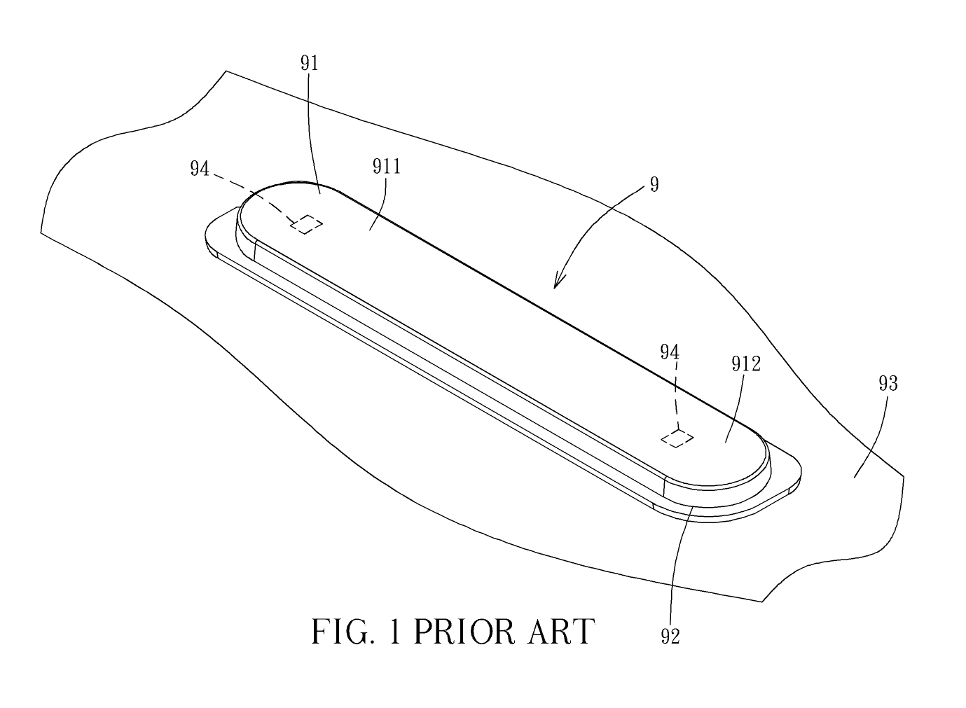

FIG. 2 is a schematic drawing of an electronic device with a key cap structure according to an embodiment of the invention.

FIG. 3 is an exploded drawing of the keycap structure, a housing and a circuit module according to the embodiment of the invention.

FIG. 4 is a schematic drawing of the keycap structure at another view according to the embodiment of the invention.

FIG. 5 is a sectional view of the key cap structure installed on the circuit module according to the embodiment of the invention.

FIG. 6 is a schematic drawing of the keycap structure assembled with an upper casing according to the embodiment of the invention.

### DETAILED DESCRIPTION

In the following detailed description of the preferred embodiments, reference is made to the accompanying drawings which form a part hereof, and in which is shown by way of illustration specific embodiments in which the invention maybe practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. Accordingly, the drawings and descriptions will be regarded as illustrative in nature and not as restrictive.

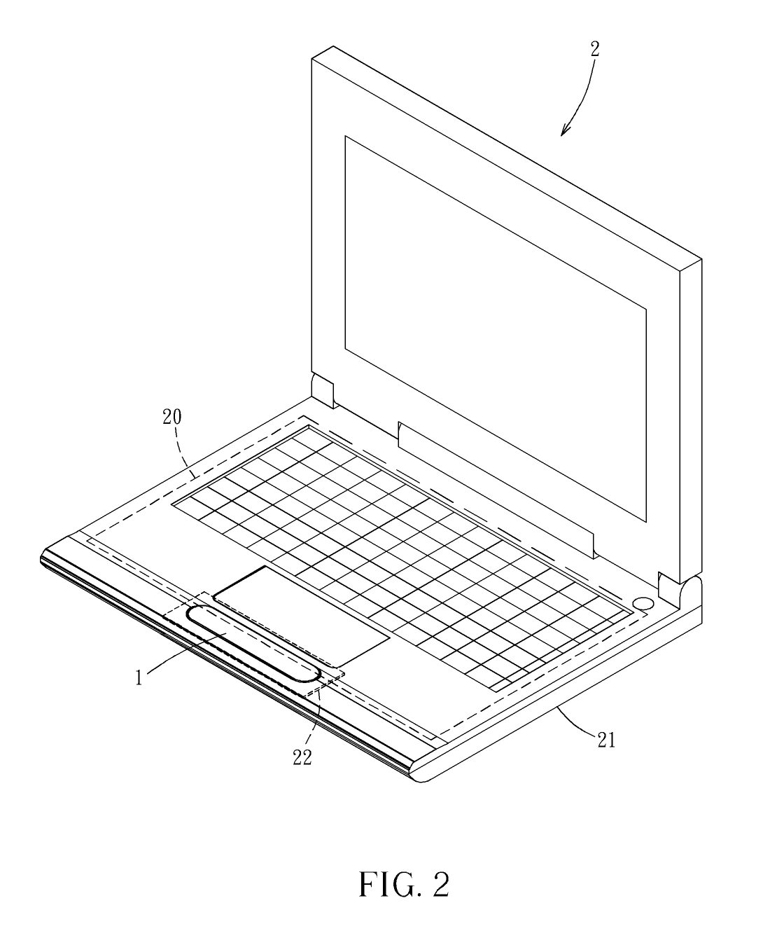

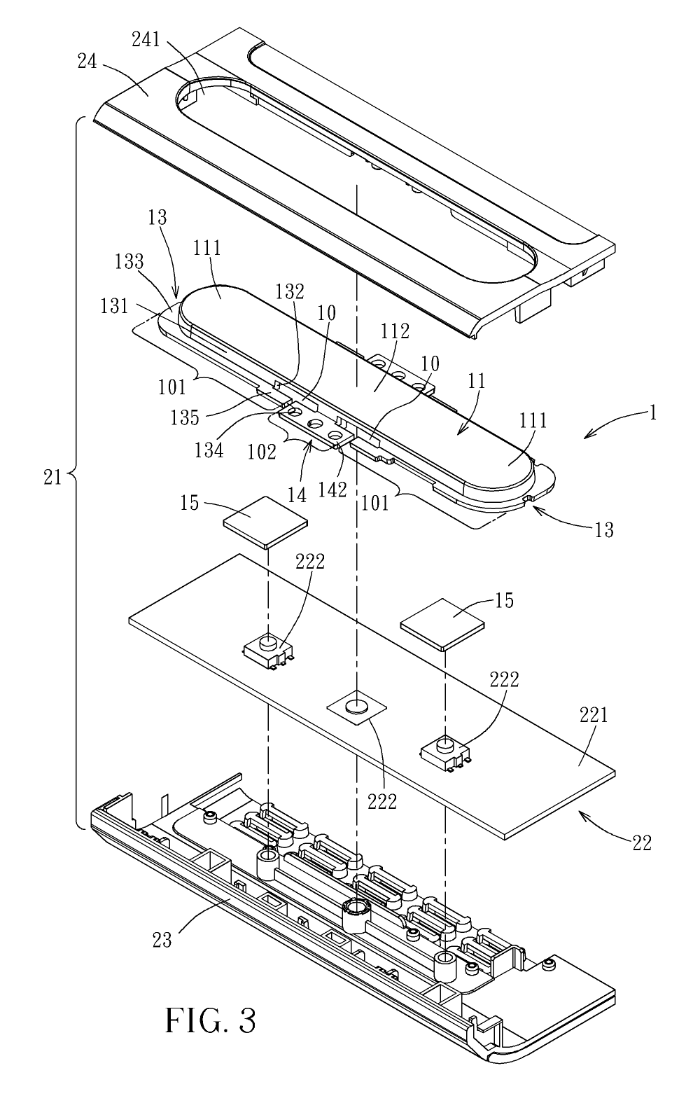

Please refer to FIG. 2 and FIG. 3. FIG. 2 is a schematic drawing of an electronic device 2 with a key cap structure 1 according to an embodiment of the invention. FIG. 3 is an exploded drawing of the key cap structure 1, a housing 21 and a circuit module 22 according to the embodiment of the invention. The keycap structure 1 is disposed on the housing 21 and corresponding to the circuit module 22. The electronic device 2 can be a notebook computer, and the housing 21 of the electronic device 2 can be a host housing of the notebook computer. The electronic device 2 further includes an electronic component module 20 disposed inside the housing 21 and electrically connected to the circuit module 22. The electronic component module 20 can include a mainboard, a CPU disposed on the mainboard, the electronic components with specific operational functions, and so on. The electronic device 2 also can be a remote controller, a mobile phone, a home appliance, a mechanical instrument, and so on. Accordingly, the electronic component module 20 has the operational function to achieve the specific purpose of the electronic device 2.

The keycap structure 1 can be a key cap of a touch pad installed on the host housing of the notebook computer. The housing 21 includes a lower casing 23 and an upper casing 24 combined with the lowercasing 23. The circuit module 22 and the key cap structure 1 are disposed between the lower casing 23 and the upper casing 24, and the key cap structure 1 is positioned above the circuit module 22. An opening 241 is formed on the upper casing 24, and the key cap structure 1 is disposed through the opening 241. The circuit module 22 includes a circuit board 221 disposed inside the housing 21 and electrically connected to the electronic component module 20, and a plurality of contact portions 222 disposed on the circuit board 221. In this embodiment, the circuit module 22 includes three contact portions 222, and each contact portion 222 can be a contact switch.

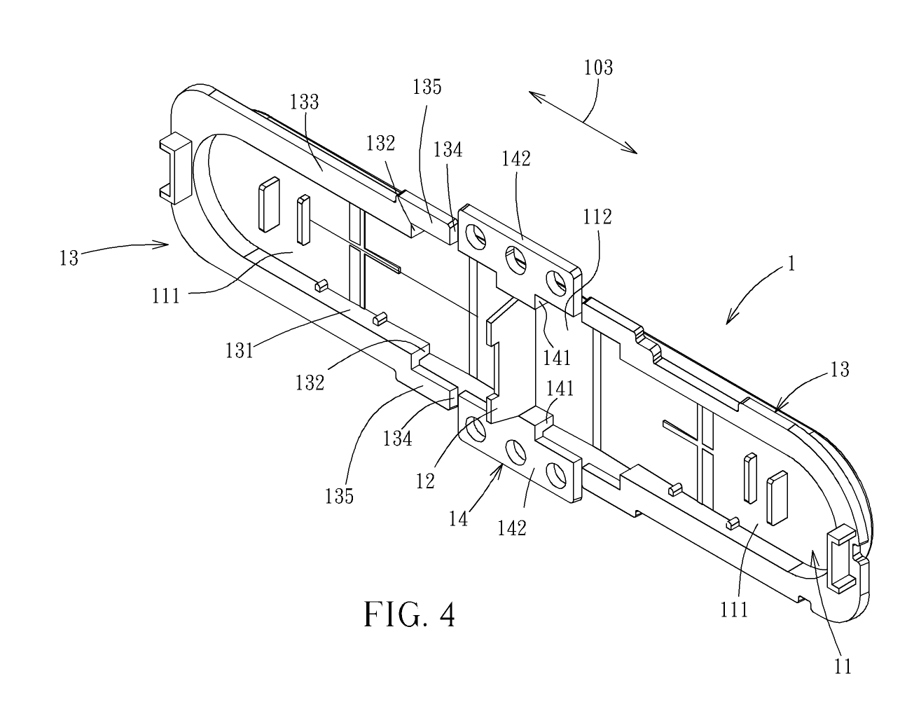

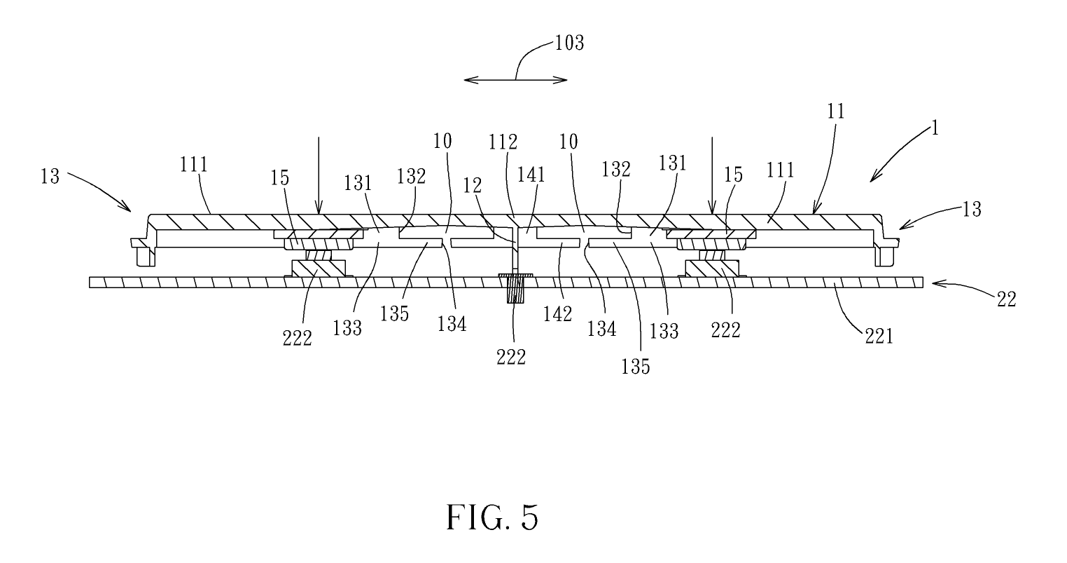

Please refer to FIG. 3 to FIG. 5. FIG. 4 is a schematic drawing of the key cap structure 1 at another view according to the embodiment of the invention. FIG. 5 is a sectional view of the key cap structure 1 installed on the circuit module 22 according to the embodiment of the invention. The key cap structure 1 includes a top wall 11, a pair of side portions 13 and a secure portion 14. The top wall 11 includes two press zones 111 respectively disposed corresponding to the two contact portions 222, and a connect zone 112 connected between the two press zones 111. The two side portions 13 are respectively connected to the two press zones 111 of the top wall 11 and extending downwardly, and the two side portions 13 are spaced apart from each other. The secure portion 14 is connected to the connect zone 112 of the top wall 11 and extending downwardly between the pair of side portions 13, so as to secure the key cap structure 1 on the housing 21.

Each press zone 111 and the corresponding connected side portion 13 are formed as a key cap unit 101. The connect zone 112 and the secure section 14 are formed as a secure unit 102, and the secure unit 102 is disposed between the two key cap units 101.

Besides, the key cap structure 1 further includes two pads 15 respectively connected to bottoms of the two press zones 111 and located in positions above and corresponding to the two contact portions 222. Each pad 15 and the corresponding press zone 111 can be integrated monolithically.

In this embodiment, the two side portions 13 are spaced apart from each other, and the secure portion 14 is disposed between the two side portions 13. The secure portion 14 is not connected to each side portion 13 directly. That is, a gap 10 is formed between each side portion 13 and the secure portion 14. A part of the top wall 11 corresponding to the gap 10 between the side portion 13 and the secure portion 14 can be deformed easily so that the key cap unit 101 can be deformed easily relative to the secure unit 102, when the press zone 111 of any key cap unit 101 is pressed downwardly in a direction indicated by an arrow as shown in FIG. 5. Hence, the structural rigidity of the key cap unit 101 is reduced due to structural design of the gap 10 between the side portion 13 and the secure portion 14, for reducing resistance to deformation of the key cap unit 101, so as to allow larger deformation of the part of the top wall 11 corresponding to the gap 10 as the press zone 111 of any key cap unit 101 is pressed downwardly. A user can only apply less pressing force to generate enough deformation of the top wall 11 of the keycap structure 1, so as to increase convenience and operational feeling of the key cap structure 1.

Further, each side portion 13 includes a surrounding wall 131 extending from the corresponding press zone 111 downwardly. Each surrounding wall 131 can be substantially in a U-shape, and each surrounding wall 131 includes two first ends 132 in a same direction. The first ends 132 of the surrounding wall 131 are spaced apart from each other and face toward the secure portion 14. It should be noticed that a plane, whereon the press zone 111 of the top wall 11 is located, is perpendicular to the downward pressing force applied to the top wall 11, and a plane, whereon the surrounding wall 131 is located, is parallel to the downward pressing force applied to the top wall 11. Hence, the structural rigidity of the surrounding wall 131 is reduced due to structural design of the gap 10 between the surrounding wall 131 of each side portion 13 and the secure portion 14, for reducing resistance to deformation of the surrounding wall 131.

Each side portion 13 further includes a flange 133 extending from a bottom of the surrounding wall 131 in a direction away from the top wall 11. The flange 133 is located on a plane parallel to a plane whereon the top wall 11 is located. Each flange 133 can be substantially in a U-shape, and each flange 133 includes two second ends 134 respectively parallel with the first ends 132 of the corresponding surrounding wall 131. Two free sections 135 are respectively formed below the top wall 11 and between the two second ends 134 and the two first ends 132. That is, a distance between the two first ends 132 of the two surrounding walls 131 is greater than a distance between the two second ends 134 of the two flanges 133.

The secure portion 14 includes two connect sections 141 extending from outer edges of the connect zone 112 of the top wall 11 downwardly, and two fix sections 142 respectively extending from the two connect sections 141 and away from the top wall 11. The two connect sections 141 are respectively disposed between the first ends 132 of the surrounding walls 131 of the pair of side portions 13. The two fix sections 142 are disposed between the second ends 134 of the flanges 133 of the pair of side portions 13 and located on a plane parallel to the plane whereon the top wall 11 is located.

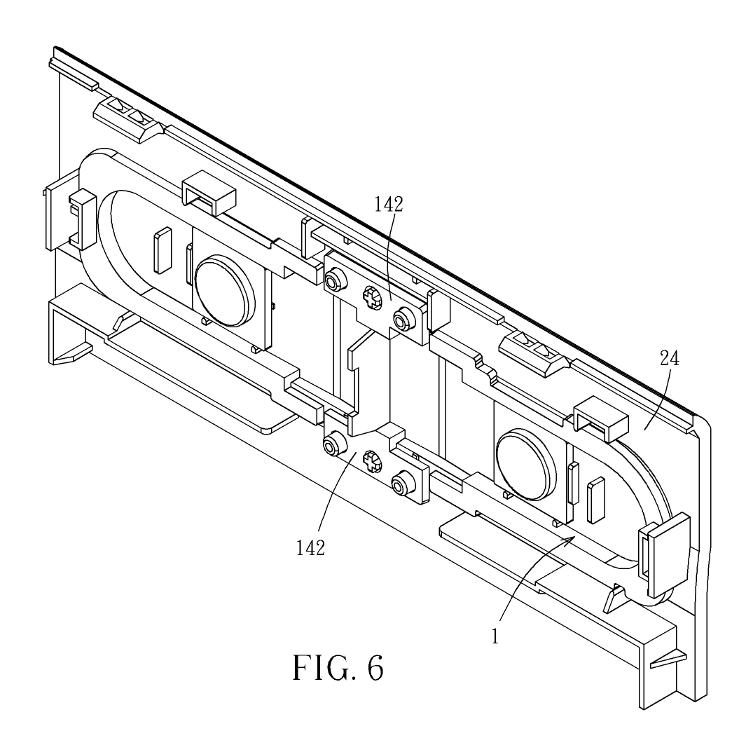

Please refer to FIG. 3 and FIG. 6. FIG. 6 is a schematic drawing of the keycap structure 1 assembled with the upper casing 24 according to the embodiment of the invention. The key cap structure 1 is fixed on a bottom of the upper casing 24 for assembling with the housing 21 via the two fix sections 142, such as an engagement of a protrusion and a hole. The flange 133 is located corresponding to a position below the upper casing 24 and nearby the opening 241.

Please refer to FIG. 3 to FIG. 5. The keycap structure 1 further includes a support rib 12 for supporting the top wall 11. The support rib 12 can be a single sheet structure. The support rib 12 extends from the connect zone 112 of the top wall 11 downwardly, and the support rib 12 is disposed between the two connect sections 141 of the secure portion 14 and located in a position corresponding the other contact portion 222. A width of the support rib 12 can be preferably less than a width of the fix section 141 along a dimensional direction 103 of the two press zones 111 and the connect zone 112 of the top wall 11 (a longitudinal direction of the top wall 11). In other words, the support rib 12 does not extend to the gap 10 between the secure portion 14 and each side portion 13, so that the support rib 12 does not provide any support for the part of the top wall 11 corresponding to the gap 10, for reducing resistance to deformation of the press zone 111, and it still keeps the supporting function for the whole top wall 11 by the supporting rib 12.

Further, a width of each connect section 141 can be substantially less than the width of the corresponding connected fix section 142 along the dimensional direction 103. It not only can increase a gap between the first end 132 of the surrounding wall 131 of each side portion 13 and the connect section 141 for reducing resistance to deformation of the top wall 11, but also can keep structural strength of the fix section 142 for fixing the upper casing 24. The width of each connect section 141 also can be substantially equal to the width of the corresponding connected fix section 142 along the dimensional direction 103.

In contrast with the prior art, the discontinuous structure between the side portions and the secure portion of the key cap structure of the present invention permits larger range of deformation formed in the top wall when the press zone of the top wall is pressed downwardly. Accordingly, the user only needs to apply less pressing force on the top wall to generate enough deformation of the top wall for contacting the contact portion, so as to increase convenience and operational feeling of the key cap structure of the present invention.

Those skilled in the art will readily observe that numerous modifications and alterations of the device and method may be made while retaining the teachings of the invention.

What is claimed is:

1. A key cap structure for disposing on a housing and corresponding to a circuit module comprising a circuit board and two contact portions disposed on the circuit board, the key cap structure comprising:
a top wall comprising:
two press zones respectively disposed corresponding to the two contact portions; and
a connect zone connected between the two press zones;
a pair of side portions respectively connected to the two press zones of the top wall and extending downwardly, the pair of side portions being spaced apart from each other; and
a secure portion connected to the connect zone of the top wall and extending downwardly between the pair of side portions, for securing the housing.

2. The key cap structure of claim 1, wherein each side portion comprises a surrounding wall extending from the corresponding press zone downwardly, each surrounding wall comprises two first ends in a same direction, and the first ends of the surrounding walls of the pair of side portions face each other.

3. The keycap structure of claim 2, wherein each side portion further comprises a flange extending from a bottom of the surrounding wall in a direction away from the top wall, the flange is located on a plane parallel to a plane whereon the top wall is located, each flange comprises two second ends respectively parallel with the first ends of the corresponding surrounding wall, and two free sections are respectively formed below the top wall and between the two second ends and the two first ends.

4. The key cap structure of claim 3, wherein the secure portion comprises:
two connect sections extending from the connect zone downwardly and disposed between the surrounding walls of the pair of side portions; and
two fix sections respectively extending from the two connect sections and away from the top wall, and the two fix sections being disposed between the flanges of the pair of side portions and located on a plane parallel to a plane whereon the top wall is located.

5. The key cap structure of claim 4, further comprising a support rib extending from the connect zone of the top wall downwardly and disposed between the two connect sections.

6. The key cap structure of claim 5, wherein a width of each connect section is substantially less than or equal to a width of the corresponding fix section along a dimensional direction of the two press zones and the connect zone of the top wall.

7. The key cap structure of claim 6, wherein a width of the support rib is less than the width of the fix section along the dimensional direction.

8. An electronic device comprising:
a housing;
an electronic component module disposed inside the housing;
a circuit module comprising:
a circuit board disposed inside the housing and electrically connected to the electronic component module; and
a plurality of contact portions disposed on the circuit board; and
a key cap structure disposed on the housing, the key cap structure comprising:
a top wall comprising:
two press zones respectively disposed corresponding to the plurality of contact portions ; and
a connect zone connected between the two press zones;
a pair of side portions respectively connected to the two press zones of the top wall and extending downwardly, the pair of side portions being spaced apart from each other; and
a secure portion connected to the connect zone of the top wall and extending downwardly between the pair of side portions, for securing the housing.

9. The electronic device of claim 8, wherein each side portion comprises a surrounding wall extending from the corresponding press zone downwardly, each surrounding wall comprises two first ends in a same direction, and the first ends of the surrounding walls of the pair of side portions face each other.

10. The electronic device of claim 9, wherein each side portion further comprises a flange extending from a bottom of the surrounding wall in a direction away from the top wall, the flange is located on a plane parallel to a plane whereon the top wall is located, each flange comprises two second ends respectively parallel with the first ends of the corresponding surrounding wall, and two free sections are respectively formed below the top wall and between the two second ends and the two first ends.

11. The electronic device of claim 10, wherein the secure portion comprises:
two connect sections extending from the connect zone downwardly and disposed between the surrounding walls of the pair of side portions; and
two fix sections respectively extending from the two connect sections and away from the top wall, and the two fix sections being disposed between the flanges of the pair of side portions and located on a plane parallel to a plane whereon the top wall is located.

12. The electronic device of claim 11, wherein the key cap structure further comprises a support rib extending from the connect zone of the top wall downwardly and disposed between the two connect sections.

13. The electronic device of claim 12, wherein a width of each connect section is substantially less than or equal to a width of the corresponding fix section along a dimensional direction of the two press zones and the connect zone of the top wall.

14. The electronic device of claim 13, wherein a width of the support rib is less than the width of the fix section along the dimensional direction.
